(19) United States
(12) Patent Application Publication
(10) Pub. No.: US 2007/0245235 A1
(43) Pub. Date: Oct. 18, 2007

(54) EFFICIENT STORAGE OF DRAWING OBJECTS IN SYNCHRONIZABLE ELECTRONIC DOCUMENTS

(75) Inventors: Suvarna Singh, Hyderabad (IN); Peter Burchhardt, Seattle, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/278,360

(22) Filed: Mar. 31, 2006

(51) Int. Cl. G06F 17/00; G06F 17/30; G06F 7/00

(52) U.S. Cl. 715/515; 707/1; 707/100; 715/503; 715/500

(57) ABSTRACT

A facility for efficiently storing drawing objects in a synchronizable document is described. The facility retrieves a template having a static portion and a dynamic portion, creates a record based on the retrieved template, computes information corresponding to the dynamic portion of the template, adds the computed information to the record, and stores the record as a portion of the synchronizable document. The synchronizable document is thereby enabled to be synchronizable because a shared object associated with a desktop version of an office productivity application is able to retrieve the synchronizable document and deserialize stored records into objects expected by the desktop version of the office productivity application. The synchronizable document contains one or more drawing objects.

### TECHNICAL FIELD

The described technology relates generally to software application programs and more particularly to efficient storage of drawing objects in synchronizable electronic documents.

### BACKGROUND

Portable computing devices, such as handheld computers, are commonly employed by users to perform numerous tasks and functions when these users need to be mobile. As an example, portable computing devices are often employed by users to work with office productivity software, such as versions of MICROSOFT OFFICE designed for use with portable computing devices. This software may be adapted from versions of the software that are designed for desktop computing devices. Software developers may adapt these applications for use with portable computing devices so that users can create, modify, or view electronic documents (“documents”) that they use on desktop computing devices. Users may synchronize their portable and desktop computing devices so that they can manipulate documents, such as by creating, modifying, or viewing the documents, using either computing device. When documents are capable of being manipulated using either computing device, they may be referred to as “synchronizable” documents.

Despite their many advantages, portable computing devices have some limitations, such as limited storage space and processing power. As a result of these limitations, versions of office productivity software designed for portable computing devices (“portable versions”) may be unable to provide the full range of features that their corresponding desktop versions (“desktop versions”) offer.

Portable versions may be unable to provide some of these features because logic designed for the desktop version of an application may be too large or complex for use with portable computing devices. As an example, several applications that comprise the MICROSOFT OFFICE suite of productivity applications use a MICROSOFT SHARED OBJECT (“MSO”) that provides functionality that is commonly employed by many of the productivity applications in the suite, such as to retrieve or store drawing objects. The MSO is an executable software component that is utilized by several application programs. It is implemented as dynamic link library (“DLL”). To retrieve charts from a file or store charts in a file, the desktop version of MICROSOFT EXCEL uses the MSO. However, the MSO is quite large and has complex logic. In a recent version of MICROSOFT OFFICE, the MSO (e.g., MSO.DLL) occupied over 10 megabytes of disk storage. It may be quite cumbersome and inefficient to adapt such a large and complex software component for use with portable computing devices.

Without a portable version of the MSO, however, portable versions of office productivity software would be unable to provide some desirable features. As an example, portable versions of MICROSOFT OFFICE may be unable to save drawing objects that can be used by desktop versions of these applications. As a further example, MICROSOFT EXCEL would be unable to exchange or synchronize charts between its desktop and portable versions. It would thus be highly desirable to enable applications designed for use with portable computing devices to synchronize drawing objects with applications designed for use with desktop computing devices.

### BRIEF DESCRIPTION OF THE DRAWINGS

FIG. 1 is a block diagram illustrating an example of a suitable computing environment in which aspects of the facility may be implemented.

FIG. 2 illustrates a portable computing device in an embodiment in which aspects of the facility may be implemented.

FIG. 3 is a block diagram illustrating a portable computing device that provides an operating environment for an embodiment of the facility in an embodiment.

FIG. 4 is a block diagram illustrating contents of a document file for use with a spreadsheet application program.

FIG. 5 is a block diagram illustrating various objects used by the facility.

FIG. 6 is a flow diagram illustrating a render_chart routine executed by the facility in some embodiments.

FIG. 7 is a flow diagram illustrating a save_charts routine executed by the facility in some embodiments.

FIG. 8 is a flow diagram illustrating a write_MSODrawingGroupRecord routine executed by the facility in some embodiments.

FIG. 9 is a flow diagram illustrating a write_MSODrawingRecords routine executed by the facility in some embodiments.

FIG. 10 is a block diagram illustrating contents of a template for use with the facility.

### DETAILED DESCRIPTION

A facility is provided for efficient storage of drawing objects in synchronizable electronic documents. In various embodiments, the facility employs templates that provide sufficient minimal information (“static data”) along with information dynamically provided by an application program (“dynamic data”) that is designed for use with personal computing devices. The static data contained in the templates and dynamic data provided by the application program are stored in a file associated with the application program. This combination of data is sufficient for both the desktop and portable versions of the application program to synchronize documents, such as documents containing drawing objects. This combination of data provides a data structure that is compatible with data expected by the MSO component of the desktop version of the application program. The MSO utilizes this data to create objects during a “deserialization” process that occurs when the file is read.

In various embodiments, a desktop version of an office productivity software stores a data section and a visual section in its data files. As an example, MICROSOFT EXCEL stores data and visual sections in its workbook files. The data section contains sufficient information to redraw a chart dynamically, such as by recalculating portions of a pie chart or bar chart. The visual section contains visual information about the chart such as position, size, colors. The visual section may also contain sufficient information to redraw the chart quickly, such as without recalculating data contained in the data section. When the MSO stores a data file (e.g., a document) containing a MICROSOFT EXCEL workbook, it stores the data and visual sections in the data file. A version of the productivity software designed for use with portable computing devices may ignore most of the information contained in one of the sections. As an example, the portable version of MICROSOFT EXCEL ignores all but position and size information contained in the visual section and recalculates information for a chart when displaying the chart. Moreover, when the portable version of MICROSOFT EXCEL stores charts in data files, it may store or update only the data section and a minimal version of the visual section, such as position and size information. The portable version of MICROSOFT EXCEL may not store the more extensive visual section that enables MICROSOFT EXCEL to render a chart quickly without recalculating data from the data section. In various embodiments, the portable version of MICROSOFT EXCEL may not store the visual section at all.

The portable version of MICROSOFT EXCEL is able to store data files without using the MSO by employing templates and dynamically adding data. By using templates and storing only the data portion of a chart, the portable version of MICROSOFT EXCEL is able to share chart information with the desktop version of MICROSOFT EXCEL. Other office productivity software, such as other MICROSOFT OFFICE applications, may similarly be able to efficiently exchange data files having drawings between their portable and desktop versions.

Thus, the facility conserves resources of a portable computing device. When an office productivity application saves a document, only a minimal set of information is saved that may later be necessary to render a drawing contained by the document. Because the MSO is not required by the portable computing device, approximately 10 megabytes of storage are freed and complex logic is unnecessary when saving documents.

In various embodiments, the portable version of the office productivity software may remove the visual section when updating a data file. In various embodiments, the portable version of the office productivity software may retain the visual section when updating a data file but may not update this section. In various embodiments, the portable version of the office productivity software retains or updates only position and size information in the visual section.

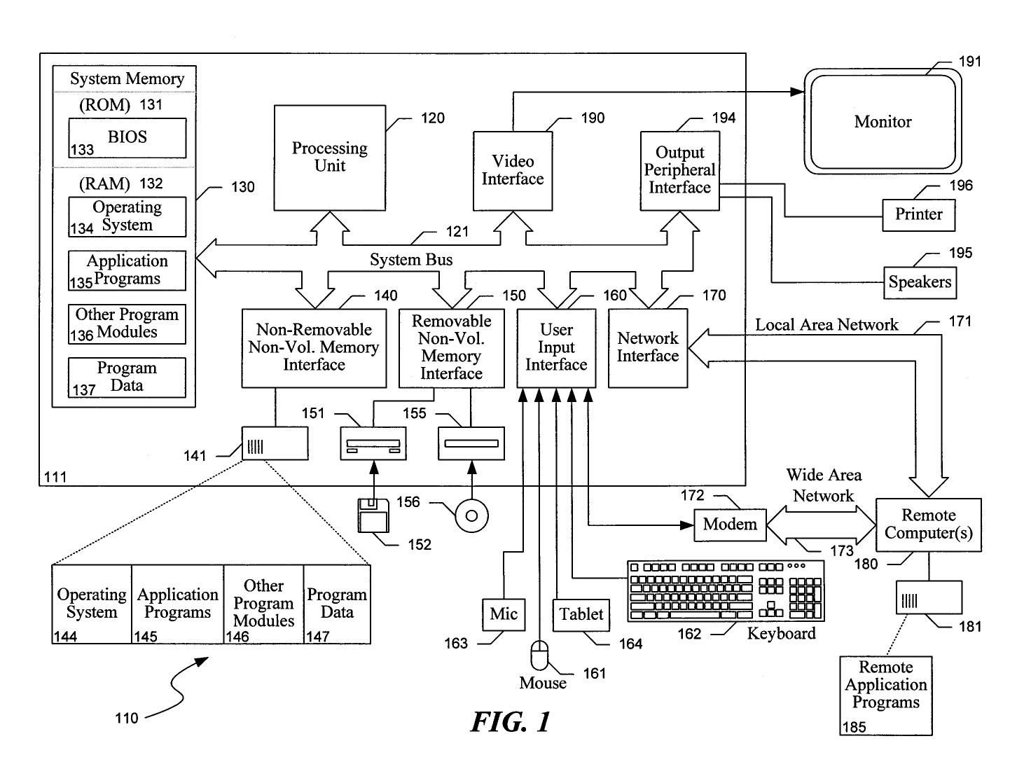

Turning now to the figures, FIG. 1 is a block diagram illustrating an example of a suitable computing system environment 110 or operating environment in which the techniques or facility may be implemented. The computing system environment 110 is only one example of a suitable computing environment and is not intended to suggest any limitation as to the scope of use or functionality of the facility. Neither should the computing system environment 110 be interpreted as having any dependency or requirement relating to any one or a combination of components illustrated in the exemplary operating environment 110.

The facility is operational with numerous other general purpose or special purpose computing system environments or configurations. Examples of well-known computing systems, environments, and/or configurations that may be suitable for use with the facility include, but are not limited to, personal computers, server computers, handheld or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The facility may be described in the general context of computer-executable instructions, such as program modules, being executed by a computer. Generally, program modules include routines, programs, objects, components, data structures, and so forth that perform particular tasks or implement particular abstract data types. The facility may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the facility includes a general purpose computing device in the form of a computer 111. Components of the computer 111 may include, but are not limited to, a processing unit 120, a system memory 130, and a system bus 121 that couples various system components including the system memory 130 to the processing unit 120. The system bus 121 may be any of several types of bus structures including a memory bus or memory controller, a peripheral bus, and a local bus using any of a variety of bus architectures. By way of example, and not limitation, such architectures include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as a Mezzanine bus.

The computer 111 typically includes a variety of computer-readable media. Computer-readable media can be any available media that can be accessed by the computer 111 and include both volatile and nonvolatile media and removable and nonremovable media. By way of example, and not limitation, computer-readable media may comprise computer storage media and communications media. Computer storage media include volatile and nonvolatile and removable and nonremovable media implemented in any method or technology for storage of information such as computer-readable instructions, data structures, program modules, or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 111. Communications media typically embody computer-readable instructions, data structures, program modules, or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communications media include wired media, such as a wired network or direct-wired connection, and wireless media, such as acoustic, RF, infrared, and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system (BIOS) 133, containing the basic routines that help to transfer information between elements within the computer 111, such as during start-up, is typically stored in ROM 131. RAM 132 typically contains data and/or program modules that are immediately accessible to and/or presently being operated on by the processing unit 120. By way of example, and not limitation, FIG. 1 illustrates an operating system 134, application programs 135, other program modules 136, and program data 137.

The computer 111 may also include other removable/nonremovable, volatile/nonvolatile computer storage media. By way of example only, FIG. 1 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a nonremovable memory interface, such as an interface 140, and the magnetic disk drive 151 and optical disk drive 155 are typically connected to the system bus 121 by a removable memory interface, such as an interface 150.

The drives and their associated computer storage media, discussed above and illustrated in FIG. 1, provide storage of computer-readable instructions, data structures, program modules, and other data for the computer 111. In FIG. 1, for example, the hard disk drive 141 is illustrated as storing an operating system 144, application programs 145, other program modules 146, and program data 147. Note that these components can either be the same as or different from the operating system 134, application programs 135, other program modules 136, and program data 137. The operating system 144, application programs 145, other program modules 146, and program data 147 are given different numbers herein to illustrate that, at a minimum, they are different copies. A user may enter commands and information into the computer 111 through input devices such as a tablet or electronic digitizer 164, a microphone 163, a keyboard 162, and a pointing device 161, commonly referred to as a mouse, trackball, or touch pad. Other input devices not shown in FIG. 1 may include a joystick, game pad, satellite dish, scanner, or the like. These and other input devices are often connected to the processing unit 120 through a user input interface 160 that is coupled to the system bus 121, but may be connected by other interface and bus structures, such as a parallel port, game port, or a universal serial bus (USB). A monitor 191 or other type of display device is also connected to the system bus 121 via an interface, such as a video interface 190. The monitor 191 may also be integrated with a touch-screen panel or the like. Note that the monitor 191 and/or touch-screen panel can be physically coupled to a housing in which the computer 111 is incorporated, such as in a tablet-type personal computer. In addition, computing devices such as the computer 111 may also include other peripheral output devices such as speakers 195 and a printer 196, which may be connected through an output peripheral interface 194 or the like.

The computer 111 may operate in a networked environment using logical connections to one or more remote computers, such as a remote computer 180. The remote computer 180 may be a personal computer, a server, a router, a network PC, a peer device, or other common network node, and typically includes many or all of the elements described above relative to the computer 111, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprisewide computer networks, intranets, and the Internet. For example, in the present facility, the computer 111 may comprise the source machine from which data is being migrated, and the remote computer 180 may comprise the destination machine. Note, however, that source and destination machines need not be connected by a network or any other means, but instead, data may be migrated via any media capable of being written by the source platform and read by the destination platform or platforms.

When used in a LAN networking environment, the computer 111 is connected to the LAN 171 through a network interface or adapter 170. When used in a WAN networking environment, the computer 111 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 111, or portions thereof, may be stored in the remote memory storage device 181. By way of example, and not limitation, FIG. 1 illustrates remote application programs 185 as residing on the memory storage device 181. It will be appreciated that the network connections shown are exemplary and other means of establishing a communications link between the computers may be used.

While various functionalities and data are shown in FIG. 1 as residing on particular computer systems that are arranged in a particular way, those skilled in the art will appreciate that such functionalities and data may be distributed in various other ways across computer systems in different arrangements. While computer systems configured as described above are typically used to support the operation of the facility, one of ordinary skill in the art will appreciate that the facility may be implemented using devices of various types and configurations, and having various components.

The techniques may be described in the general context of computer-executable instructions, such as program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

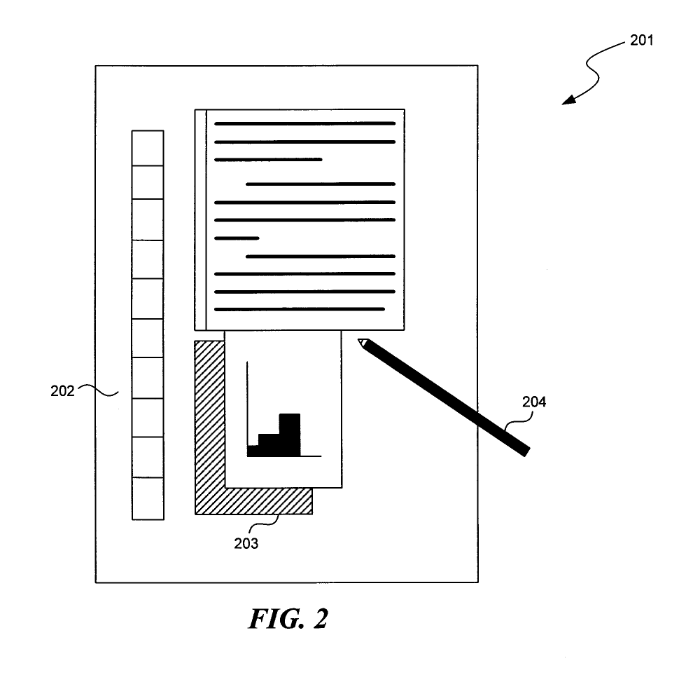

FIG. 2 illustrates a portable computing device in an embodiment in which aspects of the facility may be implemented. An example of a portable computing device is a pen-based personal computing system 201 that can be used in accordance with various aspects of the present invention. Any or all of the features, subsystems, and functions in the system of FIG. 1 can be included in the computer of FIG. 2. The pen-based personal computing system 201 includes a display surface 202, e.g., a digitizing flat panel display, such as a liquid crystal display (LCD) screen, on which multiple windows 203 may be displayed. Using a stylus 204, a user can select, highlight, and write on the digitizing display area. Other types of pen digitizers, e.g., optical digitizers, and touch-sensitive digitizers may also be used. The pen-based personal computing system 201 interprets gestures made using the stylus 204 in order to manipulate data, enter text, and execute conventional computer application tasks, such as creating, editing, and modifying spreadsheets, word processing programs, and the like.

The stylus 204 may be equipped with buttons or other features to augment its capabilities. As an example, the stylus could be implemented as a “pencil” or “pen,” in which one end constitutes a writing portion and the other end constitutes an “eraser” end, and which, when moved across the display, indicates portions of electronic ink on the display that are to be erased. Other types of input devices, such as a mouse, trackball, keyboard, or the like, also could be used. Additionally, a user's own finger could be used for selecting or indicating portions of the displayed image on a touch-sensitive or proximity-sensitive display. Consequently, the term “user input device,” as used herein, is intended to have a broad definition and encompasses many variations on well-known input devices.

Additional examples of portable computing devices include, but are not limited to, handheld or palm-top computing systems, personal digital assistants (“PDAs”), pocket personal computers, mobile and cellular telephones, pagers, communications devices, watches, appliances, and any other devices or systems that may be designed to be portable or have storage or processing constraints.

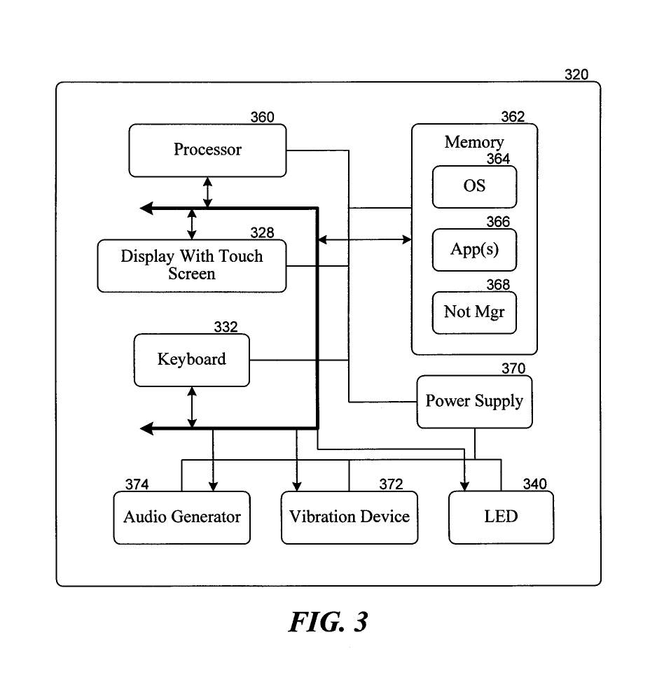

FIG. 3 is a block diagram illustrating a portable computing device that provides an operating environment for an embodiment of the facility in an embodiment. The figure and the following discussion are intended to provide a brief, general description of a suitable computing environment in which the facility may be implemented. It should be understood that the computing device in FIG. 3 is only exemplary and is not meant to limit the invention. FIG. 3 describes a computing environment such as may be found in a portable computing device, such as a PDA. However, it should be understood that the facility is not limited to PDAs. The facility may be practiced with other computer system configurations, including multiprocessor systems, microprocessor-based or programmable consumer electronics, network PCs, minicomputers, mainframe computers, wireless telephones, pagers, and the like. The facility may also be practiced in distributed computing environments where tasks are performed by remote processing devices that are linked through a communications network. In a distributed computing environment, program modules may be located in both local and remote memory storage devices.

With reference to FIG. 3, an exemplary system for implementing the invention includes a portable computing device 320. The portable computing device 320 has a processor 360, a memory 362, a display 328, and a keyboard 332. The memory 362 generally includes both volatile memory (e.g., RAM) and nonvolatile memory (e.g., ROM, PCMCIA cards, etc.). An operating system 364 is resident in the memory 362 and executes on the processor 360. The portable computing device 320 includes an operating system 364 such as the “WINDOWS CE” operating system from MICROSOFT Corporation or another operating system.

One or more application programs 366 are loaded into the memory 362 and run on the operating system 364. Examples of applications include e-mail programs, scheduling programs, personal information management programs, word processing programs, spreadsheet programs, and so forth. Another example of an application program 366 is a web browser program module such as the “POCKET INTERNET EXPLORER” web browser from MICROSOFT Corporation or another web browser.

The portable computing device 320 also has a notification manager 368, loaded in the memory 362, which executes on the processor 360. The notification manager 368 handles notification requests from the application program 366.

The portable computing device 320 has a power supply 370, which is implemented as one or more batteries. The power supply 370 might further include an external power source that overrides or recharges the built-in batteries, such as an AC adapter or a powered docking cradle.

The portable computing device 320 is also shown with three types of external notification mechanisms: an LED 340, a vibration device 372, and an audio generator 374. These devices are directly coupled to the power supply 370 so that when activated they remain on for a duration dictated by the notification mechanism even though the processor and other components might shut down to conserve battery power. The LED 340 may remain on indefinitely until the user takes action. The current versions of the vibration device 372 and audio generator 374 use too much power for today's handheld computing device's batteries, and so they are configured to turn off when the rest of the system does or at some finite duration after activation.

The portable computing device 320 may also include a transmitter (not shown) and a receiver (not shown) for communicating with a wireless network such as a cellular network. The transmitter is used to convert speech, text, or other data into electrical impulses for transmission. The receiver is used to receive transmission signals and reproduce them in their original form (audio, video, etc.). The portable computing device 320 may also include a wireless modem (not shown) well known to those skilled in the art so that the device 320 may be used to view and interact with the content of a global computer network such as the Internet.

Although not required, the facility will be described in the context of computer-executable instructions, such as program modules, being executed by a computing device. Generally, program modules include routines, programs, objects, components, data structures, etc., that perform particular tasks or implement particular abstract data types.

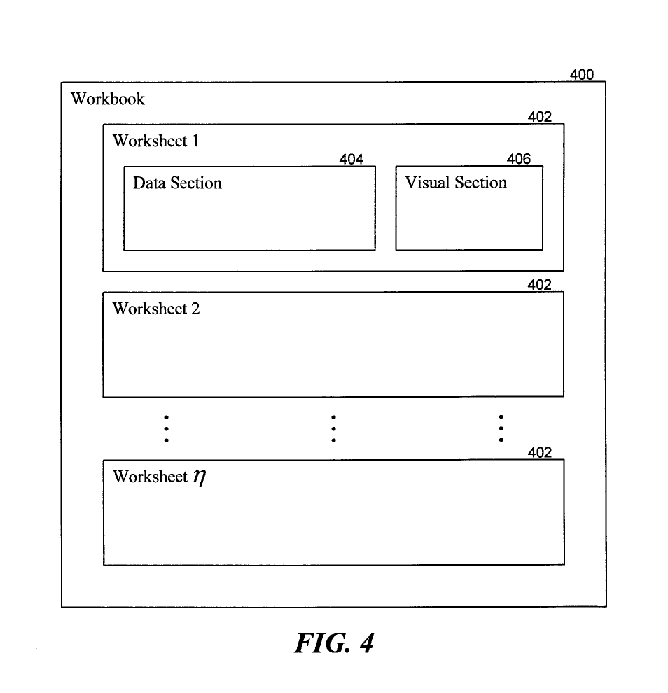

FIG. 4 is a block diagram illustrating contents of a document (e.g., a data file) for use with a spreadsheet application program. The document file may contain a workbook 400. A workbook contains some data but is mostly a collection of worksheets.

A workbook may comprise one or more worksheets 402. Users can use worksheets to organize related information. Users can enter and edit data on several worksheets and can cause the spreadsheet application program to perform calculations based on data contained in the worksheets. Users can also cause the spreadsheet application program to create a chart and place the chart either on a worksheet containing its related data or on a separate chart sheet. A chart sheet is a worksheet that contains only a chart. The data relating to the chart sheet may be present in a separate worksheet. In the workbook illustrated in FIG. 4, worksheet 1 has a chart. When a worksheet has a chart, data in the document file relating to the worksheet has a data section 404 and a visual section 406. The data and visual sections are stored with the workbook when a desktop version of the spreadsheet application program stores the workbook. They may be stored with an indication of an association with a worksheet.

The data section 404 may contain data relating to the worksheet. As an example, the data section may contain data relating to sales by geographical region. When a chart is created, such as a pie chart, slices of the pie chart may be determined based on a percent of total sales for each geographical region as identified in the data section.

As discussed above, the visual section 406 may have data relating to the visual presentation of the chart. As an example, the visual section may have information relating to colors of each slice of the pie chart, position of the pie chart in relation to the worksheet on which the pie chart appears, size of the pie chart, and so on. The visual section may also have information that may be utilized by the spreadsheet application program to render the pie chart quickly. As an example, the visual section may have a bitmap of the pie chart representing its rendering as it was last calculated. When the desktop version of the spreadsheet application program first displays the pie chart contained in a previously stored workbook, it may draw the chart based on the bitmap stored in the visual section. The spreadsheet application program may then recalculate portions of the pie chart based on changes in its corresponding data. In so doing, the desktop version of the spreadsheet application program optimizes its performance.

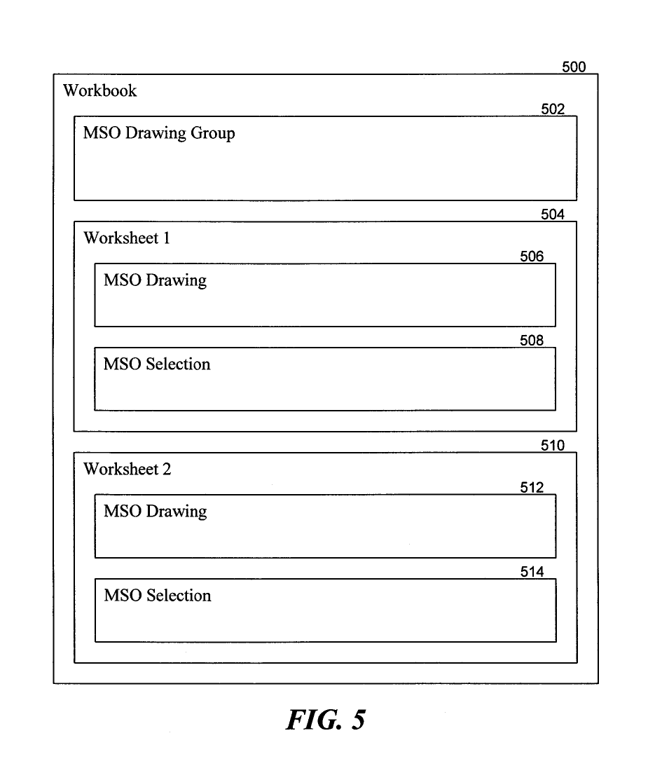

FIG. 5 is a block diagram illustrating various objects used by the facility. The MSO stores objects in data files as records. As an example, the desktop version of MICROSOFT EXCEL utilizes three types of MSO records in association with charts. These are MSO Drawing Group 502, MSO Drawing 506 and 512, and MSO Selection 508 and 514. The desktop version of MICROSOFT EXCEL may store these objects in the data file when it stores (e.g., serializes) files to disk, such as when a user saves a workbook. The portable version of MICROSOFT EXCEL utilizes a template to create a file having these objects. These objects may be stored in a data file corresponding to an application program, such as a workbook data file 500.

The MSO Drawing Group is a workbook-level object. There is one MSO Drawing Group object per workbook, and it stores drawing-related information for its corresponding workbook. As examples, this object may store information such as a number of worksheets containing charts, a number of charts for each of the worksheets, identifiers for the charts, and so on.

Each MSO Drawing object is associated with a worksheet and contains all chart objects associated with its corresponding worksheet. As examples, this object may store information such as identifiers for each chart and information relating to each chart of the worksheet with which the object is associated. In the illustration, MSO Drawing object 506 corresponds to a worksheet (“Worksheet 1”) 504 and MSO Drawing object 512 corresponds to a different worksheet (“Worksheet 2”) 510. A worksheet may be associated with multiple MSO Drawing objects, such as when multiple charts are associated with a worksheet. When a worksheet has multiple charts, the first MSO Drawing object has more data than subsequent MSO Drawing objects.

The MSO Selection object is also associated with a worksheet and contains an indication of an object that is selected for the worksheet. When an object is selected, it appears to be highlighted when the worksheet is displayed to a user. It may also be the object that receives input provided by a user using an input device, such as a keyboard. In the illustration, MSO Selection object 508 corresponds to Worksheet 1 and MSO Selection object 514 corresponds to Worksheet 2.

In various embodiments, these objects may be stored as records in a binary interchange file format (“BIFF8”). These records, when generated by the MSO, may have a hierarchy associated with a data file (e.g., a workbook). At the root of the hierarchy is the MSO Drawing Group object. The MSO Drawing Group object may be associated with one or more MSO Drawing objects and MSO Selection objects. As previously described, the MSO Drawing objects and MSO Selection objects are associated with worksheets of the workbook. These records may be categorized into two groups: atoms and containers.

Atoms are records that contain information about an MSO Drawing object. Containers are records that contain atoms and other containers. When serialized to disk, atoms and containers share a common record header and body structure. Atoms have a record header followed by some data relating to the record represented by the atom. Containers have a record header followed by some data relating to the record. Containers may contain atoms or additional containers.

Objects in the records may have unique identifiers that may be employed by various aspects of the facility to identify or reference the objects. These identifiers may be associated with workbooks or worksheets. In various embodiments, it may be possible to determine the association based on the identifier, such as by calculating a function based on the identifier. The function may identify a worksheet based on an object's unique identifier.

As already described, these records can be created by using templates. The templates have information that is similar to a file stored by the MSO and may appear to the MSO to be serialized objects. The templates may have static information and dynamically added information. The static information may be contained in the templates would typically not change. A portable version of an office productivity application may dynamically add information that changes, such as information relating to charts stored in worksheets.

Thus, although the desktop version of an office productivity application may use the MSO to serialize (e.g., store) and deserialize (e.g., load) records representing objects, the portable version of the application may be capable of using templates to store the records without employing the MSO.

In various embodiments, a worksheet may have multiple associated MSO Drawing records, such as one record per chart appearing on the worksheet.

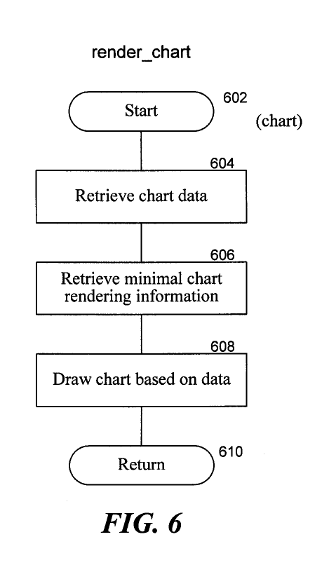

FIG. 6 is a flow diagram illustrating a render_chart routine executed by the facility in some embodiments. The routine may be employed by a portable version of a spreadsheet application program, such as MICROSOFT EXCEL, to render a chart. The routine begins at block 602, where it receives an indication of a chart, such as a chart identifier, as a parameter.

At block 604, the routine retrieves chart data. As an example, the routine may retrieve the chart data from records described above in relation to FIG. 5. The routine may determine which worksheet the chart is associated with based on the indication of the chart received at block 602. As an example, the routine may calculate a worksheet identifier based on the received chart identifier.

At block 606, the routine retrieves minimal chart rendering information from the records. In various embodiments, if a visual section is present, the spreadsheet application program may utilize information contained in the visual section. However, as previously described, the portable version of the spreadsheet application program does not need most of the information contained in the visual section and may ignore it. It may only utilize position and size information.

At block 608, the routine draws the chart based on the data retrieved at block 606. The routine may use conventional processes to draw the chart.

At block 610, the routine returns.

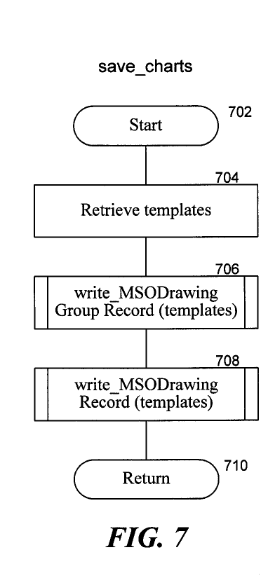

FIG. 7 is a flow diagram illustrating a save_charts routine in an embodiment. The routine begins at block 702.

At block 704, the routine retrieves templates for storing charts. The routine may retrieve these templates from memory or another storage device. In various embodiments, the templates may be built into the portable version of the spreadsheet application program.

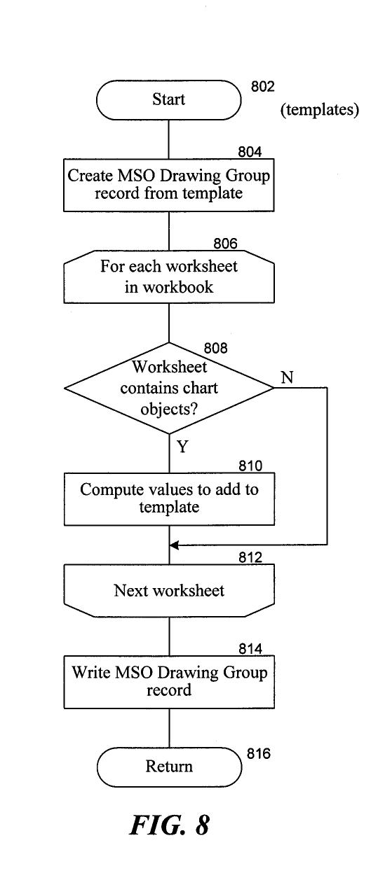

At block 706, the routine invokes a write_MSODrawingGroupRecord subroutine, which is described below in greater detail in relation to FIG. 8. The routine provides indications of some of the templates retrieved at block 704 as parameters.

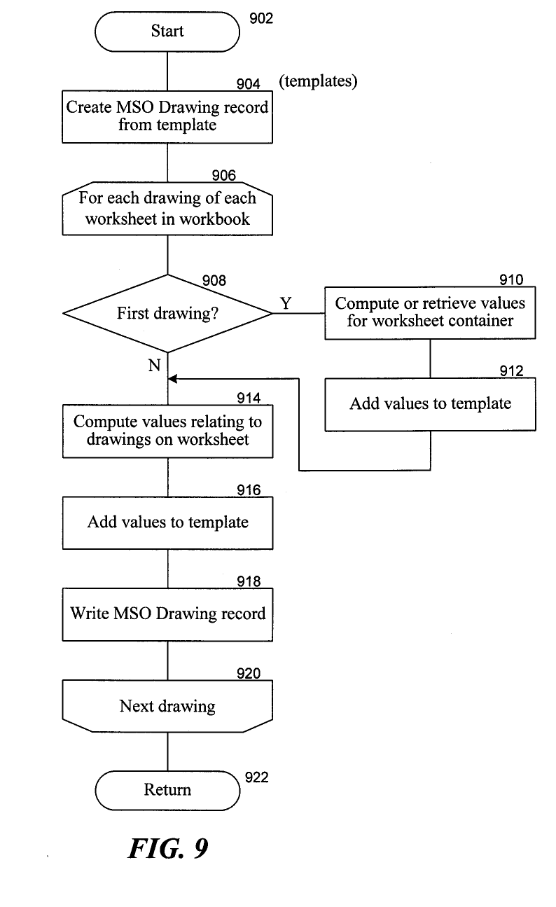

At block 708, the routine invokes a write_MSODrawingRecords subroutine, which is described below in greater detail in relation to FIG. 9. The routine provides indications of some of the templates retrieved at block 704 as parameters.

At block 710, the routine returns.

FIG. 8 is a flow diagram illustrating a write_MSODrawingGroupRecord routine in an embodiment. The routine may be invoked to create and store MSO Drawing Group records. The routine begins at block 802 where it receives templates as parameters. The routine populates portions of the received templates and stores them, such as in a storage device associated with the portable computing device.

At block 804, the routine creates an MSO Drawing Group record from the received templates. This record may contain static information and dynamic information. The routine retrieves the static information from the template. The routine next computes dynamic information to add to the record.

Between blocks 806-812, the routine computes values to be added to the record. At block 806, the routine selects a worksheet in a workbook that is being stored.

At block 808, the routine determines whether the selected worksheet contains chart objects. If the selected worksheet contains chart objects, the routine continues at block 810. Otherwise, the routine continues at block 812.

At block 810, the routine computes or retrieves values to be added to the record. As examples, the routine may calculate a size for the container based on the information to be added, an indication of a range of identifiers for drawing objects contained in the workbook, a total number of drawing objects to be stored, etc. The routine may then store the computed or retrieved values in the record.

At block 812, if other worksheets remain in the workbook to be processed, then the routine selects another worksheet and continues at block 808 to process another worksheet. Otherwise, the routine continues at block 814.

At block 814, the routine writes the record to storage.

At block 816, the routine returns.

FIG. 9 is a flow diagram illustrating a write_MSODrawingRecords routine in an embodiment. The routine may be invoked to create and store MSO drawing records. The routine begins at block 902 where it receives templates as parameters. The routine populates portions of the received templates and stores them in a storage device associated with the portable computing device.

At block 904, the routine creates an MSO Drawing record from the received templates. This record may contain static information and dynamic information. The routine retrieves the static information from the template. The routine next computes dynamic information to add to the record.

Between blocks 906-920, the routine computes values to be added to the record based on information that it retrieves or computes from each drawing of each worksheet of a workbook. At block 906, the routine selects a drawing from a worksheet of the workbook.

At block 908, the routine determines whether the selected drawing is the first drawing for which values are to be added to the template. If that is the case, the routine continues at block 910. Otherwise, the routine continues at block 914.

At block 910, the routine computes values for a worksheet container to be populated in the record. As examples, the routine may compute or retrieve values for a number of drawing objects in the selected worksheet, identifiers of drawing objects in the worksheet, an identifier associating the worksheet with the drawing objects, and a size for a container of the record based on information to be added to the record.

At block 912, the routine adds the computed or retrieved values to the record.

At block 914, the routine computes or retrieves values relating to the selected drawing. The routine may retrieve an identifier of the selected object, information relating to the drawing's dimensions, colors, etc.

At block 916, the routine adds the retrieved or computed values to the record.

At block 918, the routine writes the record to storage.

At block 920, if other drawing objects remain in the workbook to be processed, then the routine selects another drawing object and continues at block 908 to process another drawing object. Otherwise, the routine continues at block 922.

The routine returns at block 922.

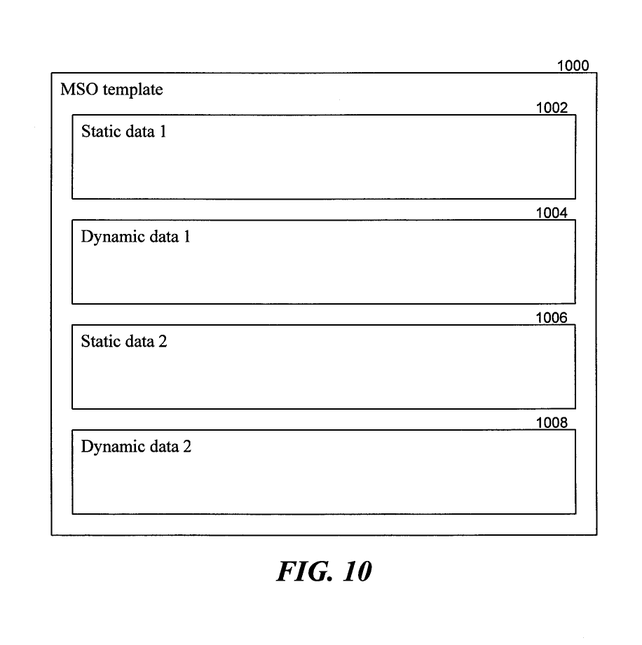

FIG. 10 is a block diagram illustrating contents of a template for use with the facility. The illustrated template 1000 provides an example of a template that may be used to create MSO Drawing Group, MSO Drawing, or MSO Selection records. The templates have one or more areas containing static data such as static areas 1002 and 1006. The templates also have one or more areas for adding dynamic data, such as dynamic areas 1004 and 1008. Static data may include information such as version numbers. Dynamic data may include information such as a size of a container or other data structures added to the record, number of worksheets containing charts, number of charts, identifiers of drawing objects, and so on.

An MSO Drawing Group template has static data such as information relating to containers and atoms, version numbers, identifiers, document-wide properties such as drawing properties, etc. Dynamic data associated with an MSO Drawing Group may include, e.g., sizes of sub-records, numbers of worksheets containing charts, number of identifier clusters (e.g., as a mechanism for associating charts with worksheets), total number of objects, number of charts for each worksheet, etc.

An MSO Drawing template has static data such as information relating to containers and atoms stored in the record, shape information for shapes in the drawing, etc. Dynamic data associated with a drawing may include, e.g., size of sub-records, numbers of objects in worksheets, identifier-related information, cluster identifiers of worksheets, identifiers for objects, position and size information, etc.

An MSO selection template has static data such as version numbers, identifiers, lengths of following data, etc. Dynamic data associated with a selection may include, e.g., identifier of the object having focus (e.g., top-most in a z-order).

Those skilled in the art will appreciate that the logic illustrated in FIGS. 6-9 may be altered in a variety of ways. For example, the order of the blocks may be rearranged, substeps may be performed in parallel, shown steps may be omitted, other steps may be included, etc.

While FIGS. 4, 5, and 10 illustrate structures whose contents and organization are designed to make them more comprehensible by a human reader, those skilled in the art will appreciate that actual structures used by the facility may differ from the structures shown, in that they, for example, may be organized in a different manner, may contain more or less information than shown, may be compressed and/or encrypted, etc.

It will be appreciated by those skilled in the art that the above-described facility may be straightforwardly adapted or extended in various ways. For example, the facility may be used with any application software having complex logic used with a desktop version whose functionality can be straightforwardly implemented using templates in a portable version. While the foregoing description makes reference to particular embodiments, the scope of the invention is defined solely by the claims that follow and the elements recited therein.

We claim:

1. A method performed by a computer system for efficiently storing drawing objects in a synchronizable document, comprising:
receiving a request to store the synchronizable document;
retrieving a template, the template having a static portion and a dynamic portion, the static portion having information that is copied to the synchronizable document when the synchronizable document is stored, the dynamic portion having information that is dynamically added to the synchronizable document when the synchronizable document is stored;
creating a record based on the retrieved template, the creating including copying verbatim the static portion of the retrieved template into the record;
computing information to be dynamically added to the dynamic portion of the template, the computing based on information from a drawing to be stored in the synchronizable document;
adding the computed information to the created record; and
storing the record as a portion of the synchronizable document, the synchronizable document enabled to be synchronizable by the stored record.

2. The method of claim 1 wherein the document stores a workbook having worksheets and the drawing is a chart.

3. The method of claim 2 wherein the request is received from a portable version of MICROSOFT EXCEL.

4. The method of claim 3 wherein the synchronizable document is synchronizable with a desktop version of MICROSOFT EXCEL.

5. The method of claim 1 wherein only position and size information contained in a visual section of the synchronizable document is added to the created record.

6. The method of claim 1 wherein the synchronizable document is formatted to be loaded by a MICROSOFT SHARED OBJECT.

7. The method of claim 6 wherein the MICROSOFT SHARED OBJECT retrieves from the stored record the copied static portion of the retrieved template as if the stored record was not derived from a template having a static portion.

8. The method of claim 1 wherein the synchronizable document is formatted to be loaded by a software component that loads a document by deserializing records stored in the document to form objects.

9. The method of claim 1 wherein the computed information includes an indication of a number of worksheets of a workbook stored in the synchronizable document.

10. A computer-readable medium having computer-executable instructions for efficiently storing drawing objects in a synchronizable document, the method comprising:
retrieving a template, the template having a static portion and a dynamic portion;
creating a record based on the retrieved template, the creating including copying the static portion of the retrieved template into the record;
computing information corresponding to the dynamic portion of the template, the computing based on information from a drawing to be stored in the synchronizable document;
adding the computed information to the record; and
storing the record as a portion of the synchronizable document, the synchronizable document enabled to be synchronizable by the stored record.

11. The computer-readable medium of claim 10 wherein the computing includes collecting information from each worksheet of a workbook to be stored in the synchronizable document.

12. The computer-readable medium of claim 10 wherein the computing includes collecting information from each drawing object of each worksheet of a workbook to be stored in the synchronizable document.

13. The computer-readable medium of claim 10 wherein a portable version of an office productivity application stores the synchronizable document and the synchronizable document is synchronizable with a desktop version of the office productivity application.

14. The computer-readable medium of claim 13 wherein the office productivity application is MICROSOFT EXCEL.

15. The computer-readable medium of claim 10 wherein the synchronizable document is formatted to be loaded by a MICROSOFT SHARED OBJECT, the MICROSOFT SHARED OBJECT usable by desktop versions of multiple office productivity applications.

16. A system for efficiently storing drawing objects in a synchronizable document, comprising:
a template, the template having a static portion and a dynamic portion;
a component that creates a record, copies the static portion of the template into the record, dynamically adds information to a portion of the record corresponding to the dynamic portion of the template, the information relating to a drawing to be stored in the synchronizable document, and stores the created record in a synchronizable document; and
a shared object component that retrieves the synchronizable document and deserializes the synchronizable document to retrieve a drawing contained in the synchronizable document, the deserialization for providing multiple objects to an office productivity application, and the multiple objects corresponding to records.

17. The system of claim 16 wherein the shared object component is a MICROSOFT SHARED OBJECT.

18. The system of claim 16 wherein the component that creates a record is associated with a portable version of the office productivity application.

19. The system of claim 18 wherein the portable version of the office productivity application is MICROSOFT EXCEL.

20. The system of claim 16 wherein the drawing is a chart.
